(19) United States
(12) Patent Application Publication
(10) Pub. No.: US 2024/0055671 A1
(43) Pub. Date: Feb. 15, 2024

(54) Bipolar Lead-Acid Storage Battery And Method For Manufacturing Bipolar Lead-Acid Storage Battery

(71) Applicants: The Furukawa Battery Co., Ltd., Yokohama (JP); Furukawa Electric Co., Ltd., Tokyo (JP)

(72) Inventors: Satoshi Shibata, Iwaki (JP); Hideaki Yoshida, Nikko (JP); Ryo Tainaka, Iwaki (JP); Naoki Nakakita, Iwaki (JP)

(21) Appl. No.: 18/491,469

(22) Filed: Oct. 20, 2023

Related U.S. Application Data
(63) Continuation of application No. PCT/JP2022/003586, filed on Jan. 31, 2022.

(30) Foreign Application Priority Data
Apr. 20, 2021 (JP) 2021-071283

(51) Int. Cl. H01M 10/18; H01M 50/477; H01M 4/66; H01M 10/14

(52) U.S. Cl. CPC H01M 10/18; H01M 50/477; H01M 4/662; H01M 10/14; H01M 2004/028

(57) ABSTRACT

A bipolar lead-acid storage battery has both life performance to withstand long-term operation and high capacity performance. Positive electrode current collector plates include a lead alloy sheet, a mass loss per total surface area of a test piece is 100 mg/cm² or less when measured after the test piece is placed in sulfuric acid at a concentration of 38 mass % maintained at a temperature of 60° C., and a continuous anodization performed at a constant potential of 1,350 mV on a reference electrode for 28 days. A thickness of the collector plate arranged on one surface of a substrate that covers both a side of a positive electrode and a side of a negative electrode of a cell member is between 0.10 mm and 0.50 mm, and a ratio of a volume of the current collector plate to a rated capacity of the battery is between 0.11 and 0.67.

### CROSS-REFERENCE TO RELATED APPLICATION(S)

This application is a continuation of PCT Application No. PCT/JP2022/003586, filed Jan. 31, 2022, the disclosure of which is incorporated herein in its entirety by reference.

### TECHNICAL FIELD

The present invention relates to a bipolar lead-acid storage battery and a method for manufacturing a bipolar lead-acid storage battery.

### BACKGROUND

In recent years, power generation facilities using natural energy such as sunlight and wind power have increased. In such power generation facilities, because the power generation amount cannot be controlled, the power load is leveled by using a storage battery. That is, when the amount of power generation is larger than consumption, a difference is charged into the storage battery, and when the amount of power generation is smaller than consumption, a difference is discharged from the storage battery. As the storage battery described above, a lead-acid storage battery is frequently used from the viewpoint of economic efficiency, safety, and the like. As such a conventional lead-acid storage battery, for example, a bipolar lead-acid storage battery described in JP Patent Publication No. 6124894 B2 is known.

The bipolar lead-acid storage battery has a frame shape and has a resin substrate attached to the inside of a resin frame. Lead layers are arranged on both surfaces of the substrate. A positive active material layer is adjacent to the lead layer formed on one surface of the substrate, and a negative active material layer is adjacent to the lead layer formed on the other surface of the substrate. In addition, a resin spacer having a frame shape is provided, and a glass mat impregnated with an electrolytic solution is provided inside the spacer. A plurality of frames and spacers are alternately stacked, and the frames and the spacers are bonded to each other with an adhesive or the like. In addition, the lead layers formed on both surfaces of the substrate are connected via a through-hole provided in the substrate.

That is, the bipolar lead-acid storage battery described in JP Patent Publication No. 6124894 B2 includes a plurality of cell members each including a positive electrode including a positive electrode current collector plate and a positive active material layer, a negative electrode including a negative electrode current collector plate and a negative active material layer, and a separator (glass mat) interposed between the positive electrode and the negative electrode. The plurality of cell members is arranged in a stack manner with intervals, and a plurality of space forming members each form a plurality of spaces for individually housing the plurality of cell members. In addition, the space forming member includes a substrate that covers at least one of a side of the positive electrode and a side of the negative electrode of the cell member, and a frame body (a frame portion and a spacer of a bipolar plate and an end plate) that surrounds a side surface of the cell member. In addition, the cell member and the substrate of the space forming member are alternately arranged in a stack state, the cell members are electrically connected in series, and adjacent frame bodies are joined to each other.

JP Patent Publication No. 6124894 B2 describes the use of a lead foil as a lead layer arranged on both surfaces of a substrate, but the publication does not describe what kind of composition is specifically used as the lead foil.

Regarding a composition of a lead alloy for a current collector plate of a general lead-acid storage battery, for example, JP Patent Publication No. JP 5399272 B2 describes the following. Because early lead-calcium alloys usually have a relatively high content ratio (for example, 0.08% or more) of calcium and a relatively low content ratio (for example, 0.35 to 0.5%) of tin, positive electrode grids produced from these alloys have an advantage of being rapidly hardened and easily handled and pasted onto plates. However, PbCa precipitates formed on top of Sn₃Ca precipitates tend to harden the alloy and tend to lead to increased corrosion and growth of the positive electrode grids in high temperature applications. In addition, a lead alloy generally used as an alloy for a grid and having a significantly low content ratio of calcium (0.02 to 0.05%) is significantly soft, is difficult to handle, and is significantly slowly hardened. Lead alloys having a significantly low calcium content ratio usually contain a relatively low amount of tin and a relatively high amount of silver, and these alloys tend to have high corrosion resistance, but these alloys are difficult to handle and require special treatment for making a thin current collector plate (current collector sheet).

In addition. JP Patent Publication No. 3035177 B2 describes that in a case where a grid substrate having an alloy composition of 0.03 to 0.09 wt % of Ca, 1.05 to 1.50 wt % of Sn. and a balance of lead is filled with a positive active material to form a positive electrode plate, and the positive electrode plate is used as a battery, the corrosive amount of the grid substrate is suppressed to 20% or less.

In addition, JP Patent Publication No. 2003-346811 A describes a rolled lead alloy for a storage battery formed by rolling a lead alloy containing 0.5 mass % to 2.0 mass % of Ag, 0.25 mass % to 6.0 mass % of Sn, and a balance Pb. This rolled lead alloy may contain about 0.001 mass % of Ca, but the alloy does not contain about 0.03 mass % to 0.1 mass % of Ca as in a conventional Pb—Ca alloy for a storage battery. Furthermore, it is described that this rolled lead alloy is preferable as a lead alloy for a positive electrode current collector of a storage battery because a corrosive amount can be remarkably reduced as compared with a conventional Pb—Ca-based alloy although a corrosion layer having a uniform thickness is formed on a surface by oxidation as in the conventional Pb—Ca-based rolled lead alloy.

In addition, the sheets formed of the alloys described in JP Patent Publication Nos. 3035177 B2 and 2003-346811 A may be “a lead alloy sheet having a mass loss per total surface area of a test piece of 100 mg/cm² or less when measured after the test piece of the lead alloy sheet is placed in sulfuric acid at a concentration of 38 mass % maintained at a temperature of 60° C., and a continuous anodization is performed at a constant potential of 1,350 mV on a mercury/mercury sulfate reference electrode for 28 days”.

### SUMMARY

One of the causes of deterioration of the lead-acid storage battery is corrosion of the positive electrode current collector plate. As the battery use period becomes longer, corrosion of the positive electrode current collector plate progresses. When the corrosion progresses, the active material cannot be held, and the performance as a battery is deteriorated. In addition, in a case where a positive electrode current collector plate dropped due to corrosion contacts the negative electrode, a short circuit may occur.

In particular, in a case of a bipolar lead-acid storage battery, because a current distribution is a reaction on the surface, there is no need to consider charge transfer resistance, and it is possible to thin the current collector plate. However, because a distance between the positive electrode and the negative electrode is short, there is a risk that a fatal defect occurs when the corrosion of the positive electrode current collector plate is large, and suppressing the corrosion of the positive electrode current collector plate is required.

On the other hand, a lead-acid storage battery used in a power storage system needs to have life performance to withstand long-term (for example, 15 years) operation, but continuous use of a battery may cause corrosion of a positive electrode lead foil, resulting in shortening the life of the battery. In addition, because the lead-acid storage battery used in the power storage system needs to have a high battery capacity, it is required to achieve both high life performance and high capacity performance. Further, because the price of the storage battery accounts for a large proportion of the price of the power storage system, reducing the cost is desirable.

An object of the present invention is to provide a bipolar lead-acid storage battery having both life performance to withstand long-term operation and high capacity performance without a significant increase in cost.

To solve the problems described above, a first aspect of the present invention is a bipolar lead-acid storage battery having the following configurations (1) to (4).

(1) A bipolar storage battery includes a plurality of cell members each including a positive electrode including a positive electrode current collector plate and a positive active material layer, a negative electrode including a negative electrode current collector plate and a negative active material layer, and a separator interposed between the positive electrode and the negative electrode. The plurality of cell members are arranged in a stack manner with intervals, and a plurality of space forming members each form a plurality of spaces for individually housing the plurality of cell members.

(2) The space forming member includes a substrate that covers both a side of the positive electrode and a side of the negative electrode of the cell member, and the space forming member includes a frame body that surrounds a side surface of the cell member. The cell member and the substrate of the space forming member are arranged to be alternately stacked. The frame bodies adjacent to each other are joined to each other.

(3) The positive electrode current collector plate includes a lead alloy sheet having a mass loss per total surface area of a test piece of 100 mg/cm² or less when measured after the test piece of the lead alloy sheet is placed in sulfuric acid at a concentration of 38 mass % maintained at a temperature of 60° C. Continuous anodization is performed at a constant potential of 1,350 mV on a mercury/mercury sulfate reference electrode for 28 days.

(4) A thickness of the positive electrode current collector plate is 0.10 mm or more and 0.50 mm or less (i.e., between 0.10 mm and 0.50 mm, inclusive), and a ratio (A/B) of a volume A (cm³) of the positive electrode current collector plate to a rated capacity B (Ah) of the bipolar lead-acid storage battery is 0.11 or more and 0.67 or less (i.e., between 0.11 and 0.67, inclusive).

A second aspect of the present invention is a method for manufacturing a bipolar lead-acid storage battery having the configurations (1) and (2) and having the following characteristics (5) and (6).

(5) As the positive electrode current collector plate, a lead alloy sheet having a thickness of 0.10 mm or more and 0.50 mm or less is used. A mass loss per total surface area of a test piece is 100 mg/cm² or less when measured after the test piece of the lead alloy sheet is placed in sulfuric acid at a concentration of 38 mass % maintained at a temperature of 60° C. and a continuous anodization is performed at a constant potential of 1,350 mV on a mercury/mercury sulfate reference electrode for 28 days.

(6) A volume A (cm³) of the positive electrode current collector plate is set so that a ratio (A/B) of the volume A of the positive electrode current collector plate to a rated capacity B (Ah) of the bipolar lead-acid storage battery is 0.11 or more and 0.67 or less.

According to the bipolar lead-acid storage battery of an embodiment of the present invention and the bipolar lead-acid storage battery obtained by a method of the present invention, it can be expected that a bipolar lead-acid storage battery has both life performance to withstand long-term operation and high capacity performance without a significant increase in cost.

### BRIEF DESCRIPTION OF THE DRAWINGS

FIG. 1 is a cross-sectional view illustrating a schematic configuration of a bipolar lead-acid storage battery according to an embodiment of the present invention.

FIG. 2 is a partially enlarged view of the bipolar lead-acid storage battery of FIG. 1.

### DETAILED DESCRIPTION

Hereinafter, embodiments of the present invention will be described, but the present invention is not limited to the following embodiments. In the embodiments described below, technically preferable limitations are made to implement the present invention, but no limitation is an essential requirement of the present invention.

Overall Configuration

First, an overall configuration of a bipolar lead-acid storage battery of the embodiment will be described.

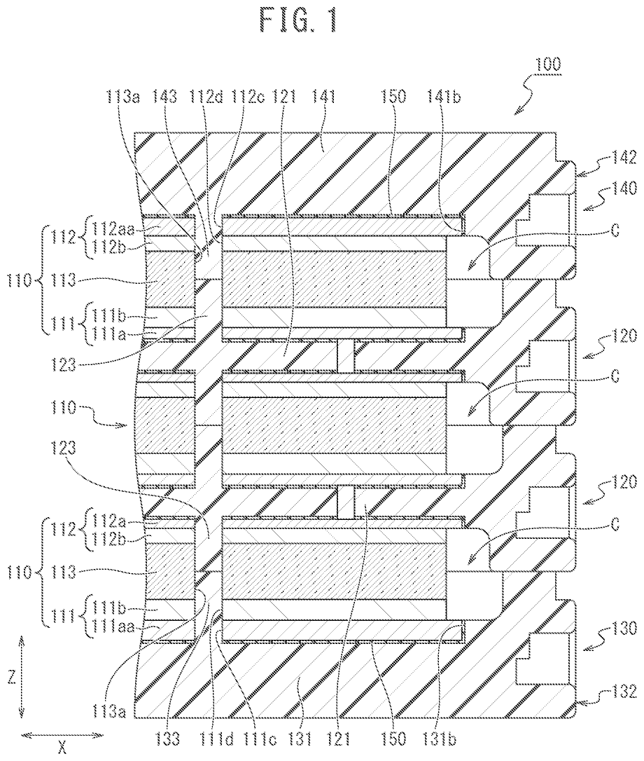

As illustrated in FIG. 1, a bipolar lead-acid storage battery 100 of the embodiment includes a plurality of cell members 110, a plurality of biplates 120, a first end plate 130, and a second end plate 140 (each also referred to as a space forming member). FIG. 1 illustrates the bipolar lead-acid storage battery 100 in which three cell members 110 are stacked, but the number of cell members 110 is determined by battery design. In addition, the number of the biplates 120 is determined according to the number of the cell members 110.

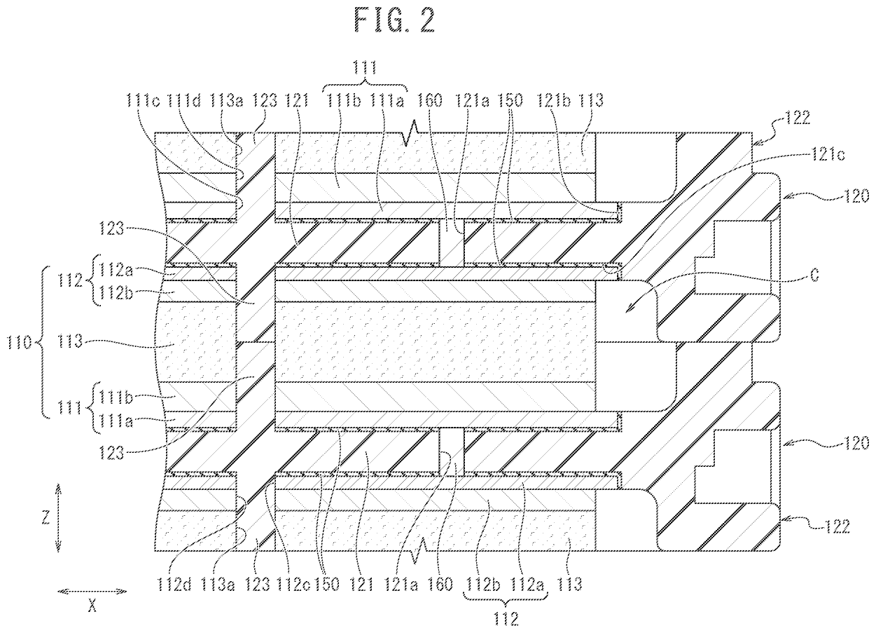

A stacking direction of the cell members 110 is defined as a Z direction (vertical direction in FIGS. 1 and 2), and a direction perpendicular to the Z direction is defined as an X direction.

The cell member 110 includes a positive electrode 11, a negative electrode 112, and a separator (electrolyte layer) 113. The separator 113 is impregnated with an electrolytic solution. The positive electrode 111 includes positive electrode lead foils 111a and 111aa (also called positive electrode current collector plates) and a positive active material layer 111b. The negative electrode 112 includes negative electrode lead foils 112a and 112aa (also called negative electrode current collector plates) and a negative active material layer 112b. The separator 113 is interposed between the positive electrode 111 and the negative electrode 112. In the cell member 110, the positive electrode lead foils 111a and 111aa, the positive active material layer 111b, the separator 113, the negative active material layer 112b, and the negative electrode lead foils 112a and 112aa are stacked in this order.

A dimension (e.g., a thickness) in the Z direction is larger (thicker) in the positive electrode lead foil 111a than in the negative electrode lead foil 112a, and the dimension is larger (thicker) in the positive active material layer 111b than in the negative active material layer 112b.

The plurality of cell members 110 are arranged in a stack manner with intervals in the Z direction, and a substrate 121 of the biplate 120 is arranged at the interval. That is, the plurality of cell members 110 are stacked with the substrate 121 of the biplate 120 interposed therebetween.

The plurality of biplates 120, the first end plate 130, and the second end plate 140 are members for forming a plurality of spaces C (also called cells) for individually housing the plurality of cell members 110.

As illustrated in FIG. 2, the biplate 120 includes a substrate 121 having a rectangular planar shape, a frame body 122 covering four end surfaces of the substrate 121, and column portions 123 vertically protruding from both surfaces of the substrate 121. The substrate 121, the frame body 122, and the column portions 123 are integrally formed of a synthetic resin. Note that the number of column portions 123 protruding from each surface of the substrate 121 may be one or more.

In the Z direction, a dimension of the frame body 122 is larger than a dimension (thickness) of the substrate 121, and a dimension between protruding end surfaces of the column portions 123 is the same as the dimension of the frame body 122. A space C is formed between the substrate 121 and the substrate 121 by stacking the plurality of biplates 120 in contact with the frame body 122 and the column portions 123, and a dimension of the space C in the Z direction is maintained by the column portions 123 that are in contact with each other.

Through-holes 111c, 111d, 112c, 112d, and 113a penetrating the column portion 123 are formed in the positive electrode lead foils 111a and 111aa, the positive active material layer 111b, the negative electrode lead foils 112a and 112aa, the negative active material layer 112b, and the separator 113, respectively.

A substrate 121 of the biplate 120 has a plurality of through-holes 121a penetrating the plate surface. A first recess 121b is formed on one surface of the substrate 121, and a second recess 121e is formed on the other surface of the substrate 121. A depth of the first recess 121b is deeper than a depth of the second recess 121c. Dimensions of the first recess 121b and the second recess 121c in the X direction and the Y direction correspond to the dimensions of the positive electrode lead 111a and the negative electrode lead foil 112a in the X direction and the Y direction.

The substrate 121 of the biplate 120 is arranged between the cell members 110 adjacent to each other in the Z direction. The substrate 121 of the biplate 120 is a substrate that covers both a side of the positive electrode 111 of the cell member 110 and a side of the negative electrode 112 of the cell member 110 adjacent thereto. The positive electrode lead foil 111a of the cell member 110 is arranged in the first recess 121b of the substrate 121 of the biplate 120 with an adhesive layer 150 interposed therebetween.

In addition, the negative electrode lead foil 112a of the cell member 110 is arranged in the second recess 121c of the substrate 121 of the biplate 120 with the adhesive layer 150 interposed therebetween.

An electrical conductor 160 is arranged in the through-hole 121a of the substrate 121 of the biplate 120, and both end surfaces of the electrical conductor 160 are in contact with and coupled to the positive electrode lead foil 111a and the negative electrode lead foil 112a. That is, the positive electrode lead foil 111a and the negative electrode lead foil 112a are electrically connected by the electrical conductor 160. As a result, all of the plurality of cell members 110 are electrically connected in series.

As illustrated in FIG. 1, the first end plate 130 includes a substrate 131 that covers a side of the positive electrode of the cell member 110, a frame body 132 that surrounds the side surface of the cell member 110, and a column portion 133 that vertically protrudes from one surface of the substrate 131 (a surface of the biplate 120 arranged closest to the side of the positive electrode, the surface facing the substrate 121). A planar shape of the substrate 131 is rectangular, four end surfaces of the substrate 131 are covered with the frame body 132, and the substrate 131, the frame body 132, and the column portion 133 are integrally formed of a synthetic resin. Note that the number of column portions 133 protruding from one surface of the substrate 131 may be one or more, but the number corresponds to the column portion 123 of the biplate 120 to be brought into contact with the column portion 133.

In the Z direction, a dimension of the frame body 132 is larger than a dimension (e.g., a thickness) of the substrate 131, and a dimension between protruding end surfaces of the column portion 133 is the same as the dimension of the frame body 132. A space C is formed between the substrate 121 of the biplate 120 and the substrate 131 of the first end plate 130 by stacking the frame body 132 and the column portion 133 in contact with the frame body 122 and the column portion 123 of the biplate 120 arranged on the outermost side (e.g., positive electrode side). A dimension of the space C in the Z direction is maintained by the column portion 123 of the biplate 120 and the column portion 133 of the first end plate 130, which are in contact with each other.

Through-holes 111c, 111d, and 113a penetrating the column portion 133 are formed in the positive electrode lead foil 111aa, the positive active material layer 111b, and the separator 113 of the cell member 110 arranged on the outermost side (e.g., the positive electrode side), respectively.

A recess 131b is formed on one surface of the substrate 131 of the first end plate 130. A dimension of the recess 131b in the X direction corresponds to a dimension of the positive electrode lead foil 111aa in the X direction. The dimension of the positive electrode lead foil 111aa arranged on one surface of the substrate 131 of the first end plate 130 in the Z direction is larger than a dimension of the positive electrode lead foil 111a arranged on one surface of the substrate 121 of the biplate 120 in the Z direction.

The positive electrode lead foil 111aa of the cell member 110 is arranged in the recess 131b of the substrate 131 of the first end plate 130 with the adhesive layer 150 interposed therebetween.

In addition, the first end plate 130 includes a positive electrode terminal electrically connected to the positive electrode lead foil 111aa in the recess 131b.

The second end plate 140 includes a substrate 141 that covers the negative electrode of the cell member 110, a frame body 142 that surrounds the side surface of the cell member 110, and a column portion 143 that vertically protrudes from one surface of the substrate 141 (a surface of the biplate 120 arranged closest to the negative electrode, the surface facing the substrate 121). A planar shape of the substrate 141 is rectangular, four end surfaces of the substrate 141 are covered with the frame body 142, and the substrate 141, the frame body 142, and the column portion 143 are integrally formed of a synthetic resin. Note that the number of column portions 143 protruding from one surface of the substrate 141 may be one or more, but the number corresponds to the column portion 123 of the biplate 120 to be brought into contact with the column portion 143.

In the Z direction, a dimension of the frame body 142 is larger than a dimension (e.g., a thickness) of the substrate 131, and a dimension between two protruding end surfaces of the column portion 143 is the same as the dimension of the frame body 142. A space C is formed between the substrate 121 of the biplate 120 and the substrate 141 of the second end plate 140 by stacking the frame body 142 and the column portion 143 in contact with the frame body 122 and the column portion 123 of the biplate 120 arranged on the outermost side (e.g., a negative electrode side). A dimension of the space C in the Z direction is maintained by the column portion 123 of the biplate 120 and the column portion 143 of the second end plate 140, which are in contact with each other.

Through-holes 112c, 112d, and 113a penetrating the column portion 143 are formed in the negative electrode lead foil 112aa, the negative active material layer 112b, and the separator 113 of the cell member 110 arranged on the outermost side (negative electrode side), respectively.

A recess 141b is formed on one surface of the substrate 141 of the second end plate 140. A dimension of the recess 141b in the X direction and the Y direction corresponds to a dimension of the negative electrode lead foil 112aa in the X direction and the Y direction. The dimension of the negative electrode lead foil 112aa arranged on one surface of the substrate 141 of the second end plate 140 in the Z direction is larger than a dimension of the negative electrode lead foil 112a arranged on the other surface of the substrate 121 of the biplate 120 in the Z direction.

The negative electrode lead foil 112aa of the cell member 110 is arranged in the recess 141b of the substrate 141 of the second end plate 140 with the adhesive layer 150 interposed therebetween.

In addition, the second end plate 140 includes a negative electrode terminal electrically connected to the negative electrode lead foil 112aa in the recess 141b.

Note that, as can be seen from the above description, the biplate 120 is a space forming member including the substrate 121 that covers both a side of the positive electrode and a side of the negative electrode of the cell member 110 and the frame body 122 that surrounds the side surface of the cell member 110. The first end plate 130 is a space forming member including the substrate 131 that covers only a side of the positive electrode (one of a side of the positive electrode and a side of the negative electrode) of the cell member 110 and the frame body 132 that surrounds the side surface of the cell member 110. The second end plate 140 is a space forming member including the substrate 141 that covers only a side of the negative electrode (one of a side of the positive electrode and a side of the negative electrode) of the cell member 110 and the frame body 142 that surrounds the side surface of the cell member 110. That is, each of the substrates 121, 131, and 141 is a substrate that covers at least one of a side of the positive electrode and a side of the negative electrode of the cell member 110, and the substrate 121 is a substrate that covers both the side of the positive electrode and the side of the negative electrode of the cell member 110.

Configuration of Current Collector Plate

A thickness of the positive electrode lead foil 111a (the positive electrode current collector plate arranged on one surface of the substrate 121) arranged in the recess 121b of the substrate 121 of the biplate 120 is 0.10 mm or more and 0.50 mm or less (i.e., between 0.10 and 0.50 mm, inclusive), and a ratio (A/B) of a volume A (cm³) of the positive electrode lead foil 111a to a rated capacity B (Ah) of the bipolar lead-acid storage battery 100 is 0.11 or more and 0.67 or less (i.e., between 0.11 and 0.67, inclusive).

In addition, the positive electrode lead foil 111a is formed of a non-heat treatment material for a rolled sheet or a cast sheet formed of a lead alloy in which a content ratio of tin (Sn) is 1.0 mass % or more and less than 2.0 mass %, a content ratio of calcium (Ca) is 0.005 mass % or more and less than 0.020 mass %, and a balance is lead (Pb) and unavoidable impurities.

In addition, a mass loss per total surface area of a test piece is 100 mg/cm² or less when measured after the test piece of the positive electrode lead foil 111a is placed in sulfuric acid at a concentration of 38 mass % maintained at a temperature of 60° C., and a continuous anodization is performed at a constant potential of 1,350 mV on a mercury/mercury sulfate reference electrode for 28 days.

The positive electrode lead foil 111aa (positive electrode current collector plate) arranged in the recess 131b of the first end plate 130 has a thickness of 0.5 mm or more and 1.5 mm or less, and is formed of a non-heat treatment material for a rolled sheet or a cast sheet formed of a lead alloy in which a content ratio of tin (Sn) is 1.0 mass % or more and less than 2.0 mass %, a content ratio of calcium (Ca) is 0.005 mass % or more and less than 0.020 mass %, and a balance is lead (Pb) and unavoidable impurities.

A thickness of the negative electrode lead foil 112a (negative electrode current collector plate arranged on the other surface of the substrate 121) arranged in the recess 121c of the substrate 121 of the biplate 120 is 0.05 mm or more and 0.3 mm or less. The alloy constituting the negative electrode lead foil 112a is, for example, a lead alloy in which a content ratio of tin (Sn) is 0.5 mass % or more and 2 mass % or less.

The negative electrode lead foil 112aa (negative electrode current collector plate) arranged in the recess 141b of the second end plate 140 has a thickness of 0.5 mm or more and 1.5 mm or less, and an alloy forming the negative electrode lead foil 112aa is, for example, a lead alloy in which a content ratio of tin (Sn) is 0.5 mass % or more and 2 mass % or less.

Action and Effect

In the bipolar lead-acid storage battery 100 of the embodiment, a thickness of the positive electrode lead foil 111a (the positive electrode current collector plate arranged on one surface of the substrate 121 of the biplate 120) arranged in the recess 121b of the biplate 120 is 0.10 mm or more and 0.50 mm or less, and a ratio (A/B) of a volume A (cm³) of the positive electrode lead foil 111a to a rated capacity B (Ah) of the bipolar lead-acid storage battery 100 is 0.11 or more and 0.67 or less. In addition, a mass loss per total surface area of a test piece is 100 mg/cm² or less when measured after the test piece of each of the positive electrode lead foils 111a and 111aa is placed in sulfuric acid at a concentration of 38 mass % maintained at a temperature of 60° C., and a continuous anodization is performed at a constant potential of 1,350 mV on a mercury/mercury sulfate reference electrode for 28 days. Therefore, the bipolar lead-acid storage battery 100 has both life performance to withstand long-term operation and high capacity performance without a significant increase in cost.

When the ratio (A/B) is less than 0.11, the positive electrode lead foil 111a is likely to be corroded and cannot withstand long-term operation. On the other hand, when the ratio (A/B) exceeds 0.67, which is too large, the volume of the positive electrode lead foil 111a becomes extremely large, such that the material cost increases. Unless a volume of a cell chamber C is increased, the amount of the electrolytic solution to be charged into the cell chamber C decreases, which may cause a decrease in battery capacity.

It is preferable that the bipolar lead-acid storage battery 100 of the embodiment is used (operated) in a state where a charge amount does not exceed 100% of the rated capacity (for example, 99% or less, 95% or less, 20% or more and 99% or less, or 25% or more and 95% or less). The operation in such a partial state of charge (PSOC) has high charging efficiency, and the corrosion of the positive electrode lead foil 111a is suppressed. That is, the bipolar lead-acid storage battery 100 of the embodiment is preferable as a lead-acid storage battery for a power storage system.

The “positive electrode lead foil having a mass loss per total surface area of a test piece of 100 mg/cm² or less when measured after the test piece of the positive electrode lead foil is placed in sulfuric acid at a concentration of 38 mass % maintained at a temperature of 60° C., and a continuous anodization is performed at a constant potential of 1,350 mV on a mercury/mercury sulfate reference electrode for 28 days” can be manufactured, for example, by a method in which a lead alloy in which a content ratio of tin (Sn) is 1.0 mass % or more and less than 2.0 mass %, a content ratio of calcium (Ca) is 0.005 mass % or more and less than 0.020 mass %, and a balance is lead (Pb) and unavoidable impurities is formed into a sheet by rolling or casting, and a heat treatment is not performed.

### Examples

Preparation of Positive Electrode Current Collector Plate

Manufacturing of Rolled Sheet and Cast Sheet

Rolled sheets and cast sheets formed of the following alloys A to E and having a thickness of 0.30 mm, and rolled sheets formed of the following alloy C and having thicknesses of 0.09 mm, 0.10 mm, 0.50 mm, and 0.60 mm were manufactured by the following method.

In a method for manufacturing rolled sheet, a lead alloy slab was rolled to a predetermined thickness by a multi-stage rolling mill and then punched into a predetermined dimension to manufacture a rolled sheet.

In a method for manufacturing cast sheet, a casting mold having a predetermined dimension and thickness was prepared, and a molten lead alloy was poured into the casting mold, cooled, and then taken out from the casting mold to manufacture a cast sheet.

Alloy A is a lead alloy in which a content ratio of tin (Sn) is 1.6 mass %, a content ratio of calcium (Ca) is 0.038 mass %, and a balance is lead (Pb) and unavoidable impurities.

Alloy B is a lead alloy in which a content ratio of tin (Sn) is 1.6 mass %, a content ratio of calcium (Ca) is 0.016 mass %, and a balance is lead (Pb) and unavoidable impurities.

Alloy C is a lead alloy in which a content ratio of tin (Sn) is 1.6 mass %, a content ratio of calcium (Ca) is 0.010 mass %, and a balance is lead (Pb) and unavoidable impurities.

Alloy D is a lead alloy in which a content ratio of tin (Sn) is 0.8 mass %, and a balance is lead (Pb) and unavoidable impurities.

Alloy E is a lead alloy in which a content ratio of tin (Sn) is 1.6 mass %, a content ratio of calcium (Ca) is 0.026 mass %, and a balance is lead (Pb) and unavoidable impurities.

Cutting Each Positive Electrode Current Collector Plate

Sample Nos. 1 to 6

Rolled sheets and cast sheets formed of the alloys A to C and having a thickness of 0.30 mm were cut into rectangular sheets having a long side of 26.7 cm and a short side of 25.0 cm (that is, an area was 667.5 cm²), and the rectangular sheets were used as positive electrode current collector plates of Sample Nos. 1 to 6. The volume of each of these positive electrode current collector plates was 20 cm³.

Sample Nos. 7 to 10

Rolled sheets and cast sheets formed of the alloy D or E and having a thickness of 0.30 mm were cut into rectangular sheets having a long side of 35.0 cm and a short side of 28.6 cm (that is, an area was 1001.0 cm²), and the rectangular sheets were used as positive electrode current collector plates of Sample Nos. 7 to No. 10. The volume of each of these positive electrode current collector plates was 30 cm³.

Sample No. 11

A rolled sheet formed of the alloy C and having a thickness of 0.09 mm was cut into a rectangular sheet having a long side of 25.0 cm and a short side of 17.8 cm (that is, an area was 445.0 cm²), and the rectangular sheet was used as a positive electrode current collector plate of Sample No. 11. The volume of each of these positive electrode current collector plates was 4 cm³.

Sample No. 12

A rolled sheet formed of the alloy C and having a thickness of 0.09 mm was cut into a rectangular sheet having a long side of 25.0 cm and a short side of 22.2 cm (that is, an area was 555.0 cm²), and the rectangular sheet was used as a positive electrode current collector plate of Sample No. 12. The volume of each of these positive electrode current collector plates was 5 cm³.

Sample No. 13

A rolled sheet formed of the alloy C and having a thickness of 0.09 mm was cut into a rectangular sheet having a long side of 35.0 cm and a short side of 31.7 cm (that is, an area was 1,109.5 cm²), and the rectangular sheet was used as a positive electrode current collector plate of Sample No. 13. The volume of each of these positive electrode current collector plates was 10 cm³.

Sample No. 14

A rolled sheet formed of the alloy C and having a thickness of 0.09 mm was cut into a rectangular sheet having a long side of 50.0 cm and a short side of 44.4 cm (that is, an area was 2,220.0 cm²), and the rectangular sheet was used as a positive electrode current collector plate of Sample No. 14. The volume of each of these positive electrode current collector plates was 20 cm³.

Sample No. 15

A rolled sheet formed of the alloy C and having a thickness of 0.09 mm was cut into a rectangular sheet having a long side of 60.0 cm and a short side of 55.6 cm (that is, an area was 3,336.0 cm²), and the rectangular sheet was used as a positive electrode current collector plate of Sample No. 15. The volume of each of these positive electrode current collector plates was 30 cm³.

Sample No. 16

A rolled sheet formed of the alloy C and having a thickness of 0.09 mm was cut into a rectangular sheet having a long side of 60.0 cm and a short side of 59.3 cm (that is, an area was 3,558.0 cm²), and the rectangular sheet was used as a positive electrode current collector plate of Sample No. 16. The volume of each of these positive electrode current collector plates was 32 cm³.

Sample No. 17

A rolled sheet formed of the alloy C and having a thickness of 0.10 mm was cut into a rectangular sheet having a long side of 25.0 cm and a short side of 16.0 cm (that is, an area was 400.0 cm²), and the rectangular sheet was used as a positive electrode current collector plate of Sample No. 17. The volume of each of these positive electrode current collector plates was 4 cm³.

Sample No. 18

A rolled sheet formed of the alloy C and having a thickness of 0.10 mm was cut into a rectangular sheet having a long side of 25.0 cm and a short side of 20.0 cm (that is, an area was 500.0 cm²), and the rectangular sheet was used as a positive electrode current collector plate of Sample No. 18. The volume of each of these positive electrode current collector plates was 5 cm³.

Sample No. 19

A rolled sheet formed of the alloy C and having a thickness of 0.10 mm was cut into a rectangular sheet having a long side of 35.0 cm and a short side of 28.6 cm (that is, an area was 1,001.0 cm²), and the rectangular sheet was used as a positive electrode current collector plate of Sample No. 19. The volume of each of these positive electrode current collector plates was 10 cm³.

Sample No. 20

A rolled sheet formed of the alloy C and having a thickness of 0.10 mm was cut into a rectangular sheet having a long side of 50.0 cm and a short side of 40.0 cm (that is, an area was 2,000.0 cm²), and the rectangular sheet was used as a positive electrode current collector plate of Sample No. 20. The volume of each of these positive electrode current collector plates was 20 cm³.

Sample No. 21

A rolled sheet formed of the alloy C and having a thickness of 0.10 mm was cut into a rectangular sheet having a long side of 60.0 cm and a short side of 50.0 cm (that is, an area was 3,000.0 cm²), and the rectangular sheet was used as a positive electrode current collector plate of Sample No. 21. The volume of each of these positive electrode current collector plates was 30 cm³.

Sample No. 22

A rolled sheet formed of the alloy C and having a thickness of 0.10 mm was cut into a rectangular sheet having a long side of 60.0 cm and a short side of 53.3 cm (that is, an area was 3,198.0 cm²), and the rectangular sheet was used as a positive electrode current collector plate of Sample No. 22. The volume of each of these positive electrode current collector plates was 32 cm³.

Sample No. 23

A rolled sheet formed of the alloy C and having a thickness of 0.30 mm was cut into a rectangular sheet having a long side of 15.0 cm and a short side of 8.9 cm (that is, an area was 133.5 cm²), and the rectangular sheet was used as a positive electrode current collector plate of Sample No. 23. The volume of each of these positive electrode current collector plates was 4 cm³.

Sample No. 24

A rolled sheet formed of the alloy C and having a thickness of 0.30 mm was cut into a rectangular sheet having a long side of 15.0 cm and a short side of 11.1 cm (that is, an area was 166.5 cm²), and the rectangular sheet was used as a positive electrode current collector plate of Sample No. 24. The volume of each of these positive electrode current collector plates was 5 cm³.

Sample No. 25

A rolled sheet formed of the alloy C and having a thickness of 0.30 mm was cut into a rectangular sheet having a long side of 20.0 cm and a short side of 16.7 cm (that is, an area was 334.0 cm²), and the rectangular sheet was used as a positive electrode current collector plate of Sample No. 25. The volume of each of these positive electrode current collector plates was 10 cm³.

Sample No. 26

A rolled sheet formed of the alloy C and having a thickness of 0.30 mm was cut into a rectangular sheet having a long side of 35.0 cm and a short side of 28.6 cm (that is, an area was 1,001.0 cm²), and the rectangular sheet was used as a positive electrode current collector plate of Sample No. 26. The volume of each of these positive electrode current collector plates was 30 cm³.

Sample No. 27

A rolled sheet formed of the alloy C and having a thickness of 0.30 mm was cut into a rectangular sheet having a long side of 35.0 cm and a short side of 30.5 cm (that is, an area was 1,067.5 cm²), and the rectangular sheet was used as a positive electrode current collector plate of Sample No. 27. The volume of each of these positive electrode current collector plates was 32 cm³.

Sample No. 28

A rolled sheet formed of the alloy C and having a thickness of 0.50 mm was cut into a rectangular sheet having a long side of 10.0 cm and a short side of 8.0 cm (that is, an area was 80.0 cm²), and the rectangular sheet was used as a positive electrode current collector plate of Sample No. 28. The volume of each of these positive electrode current collector plates was 4 cm³.

Sample No. 29

A rolled sheet formed of the alloy C and having a thickness of 0.50 mm was cut into a rectangular sheet having a long side of 11.0 cm and a short side of 9.1 cm (that is, an area was 100.1 cm²), and the rectangular sheet was used as a positive electrode current collector plate of Sample No. 29. The volume of each of these positive electrode current collector plates was 5 cm³.

Sample No. 30

A rolled sheet formed of the alloy C and having a thickness of 0.50 mm was cut into a rectangular sheet having a long side of 15.0 cm and a short side of 13.3 cm (that is, an area was 199.5 cm²), and the rectangular sheet was used as a positive electrode current collector plate of Sample No. 30. The volume of each of these positive electrode current collector plates was 10 cm³.

Sample No. 31

A rolled sheet formed of the alloy C and having a thickness of 0.50 mm was cut into a rectangular sheet having a long side of 25.0 cm and a short side of 16.0 cm (that is, an area was 400.0 cm²), and the rectangular sheet was used as a positive electrode current collector plate of Sample No. 31. The volume of each of these positive electrode current collector plates was 20 cm³.

Sample No. 32

A rolled sheet formed of the alloy C and having a thickness of 0.50 mm was cut into a rectangular sheet having a long side of 30.0 cm and a short side of 20.0 cm (that is, an area was 600.0 cm²), and the rectangular sheet was used as a positive electrode current collector plate of Sample No. 32. The volume of each of these positive electrode current collector plates was 30 cm³.

Sample No. 33

A rolled sheet formed of the alloy C and having a thickness of 0.50 mm was cut into a rectangular sheet having a long side of 30.0 cm and a short side of 21.3 cm (that is, an area was 639.0 cm²), and the rectangular sheet was used as a positive electrode current collector plate of Sample No. 33. The volume of each of these positive electrode current collector plates was 32 cm³.

Sample No. 34

A rolled sheet formed of the alloy C and having a thickness of 0.60 mm was cut into a rectangular sheet having a long side of 10.0 cm and a short side of 6.7 cm (that is, an area was 67.0 cm²), and the rectangular sheet was used as a positive electrode current collector plate of Sample No. 34. The volume of each of these positive electrode current collector plates was 4 cm³.

Sample No. 35

A rolled sheet formed of the alloy C and having a thickness of 0.60 mm was cut into a rectangular sheet having a long side of 11.0 cm and a short side of 7.6 cm (that is, an area was 83.6 cm²), and the rectangular sheet was used as a positive electrode current collector plate of Sample No. 35. The volume of each of these positive electrode current collector plates was 5 cm³.

Sample No. 36

A rolled sheet formed of the alloy C and having a thickness of 0.60 mm was cut into a rectangular sheet having a long side of 15.0 cm and a short side of 11.1 cm (that is, an area was 166.5 cm²), and the rectangular sheet was used as a positive electrode current collector plate of Sample No. 36. The volume of each of these positive electrode current collector plates was 10 cm³.

Sample No. 37

A rolled sheet formed of the alloy C and having a thickness of 0.60) mm was cut into a rectangular sheet having a long side of 20.0 cm and a short side of 16.7 cm (that is, an area was 334.0 cm²), and the rectangular sheet was used as a positive electrode current collector plate of Sample No. 37. The volume of each of these positive electrode current collector plates was 20 cm³.

Sample No. 38

A rolled sheet formed of the alloy C and having a thickness of 0.60 mm was cut into a rectangular sheet having a long side of 25.0 cm and a short side of 20.0 cm (that is, an area was 500.0 cm²), and the rectangular sheet was used as a positive electrode current collector plate of Sample No. 38. The volume of each of these positive electrode current collector plates was 30 cm³.

Sample No. 39

A rolled sheet formed of the alloy C and having a thickness of 0.60 mm was cut into a rectangular sheet having a long side of 25.0 cm and a short side of 21.3 cm (that is, an area was 532.5 cm²), and the rectangular sheet was used as a positive electrode current collector plate of Sample No. 39. The volume of each of these positive electrode current collector plates was 32 cm³.

Measurement of Corrosive Amount

Rolled sheets and cast sheets formed of the following alloys A to E and having a thickness of 0.30 mm were cut into test pieces having a width of 15 mm and a length of 70 mm. The test piece was placed in sulfuric acid at 60° C. at a concentration of 38 mass % (specific gravity 1.28), and the test piece was subjected to a continuous anodization at a constant potential (vs: Hg/Hg₂SO₄) of 1,350 mV on a mercury/mercury sulfate reference electrode for 28 days. Thereafter, a product oxide was removed. The mass was measured before and after the test, a mass loss by the test was calculated from the value, and a mass loss per total surface area of the test piece was taken as a corrosive amount (mg/cm²).

Assembly of Bipolar Lead-Acid Storage Batteries

Each of the positive electrode current collector plates of Sample Nos. 1 to 39 was used as a positive electrode lead foil 111a, and the bipolar lead-acid storage batteries Nos. 1 to 39 were assembled to have the structure illustrated in FIG. 1 and a rated capacity of 45 Ah. As the positive electrode lead foil 111aa, for each sample, a sheet having the same rectangular shape as the positive electrode lead foil 111a and having a thickness of 1.50 mm, which was obtained by the same manufacturing method using the same alloy as the positive electrode lead foil 111a, was used. Except for the positive electrode lead foils 111a and 111aa, all the samples had the same configuration.

As the negative electrode lead foil 112a, a rolled sheet formed of a lead alloy in which a content ratio of tin (Sn) was 1.6 mass % and a balance was lead (Pb) and unavoidable impurities, and having a thickness of 1.0 mm, was used. As the negative electrode lead foil 112aa, the same rolled sheet as the negative electrode lead foil 112a except that the thickness of 1.50 mm was used.

The bipolar lead-acid storage batteries used each included the positive active material layer 111b and the negative active material layer 112b formed of a lead compound, and the separator 113 formed of a glass fiber. Each battery had a thickness corresponding to a rated capacity of 45 Ah.

Capacity Test

Each of the bipolar lead-acid storage batteries Nos. 1 to 39 was placed in a water tank in which a water temperature was controlled to 25° C.±2° C., the bipolar lead-acid storage battery was discharged at a 10-hour rate current (4.5 A) of a rated capacity (45 Ah) until a terminal voltage of the battery dropped to 1.8 V/cell, a discharge duration was recorded, and a 10-hour rate capacity was calculated from the discharge current and the discharge duration.

Life Test

First, the battery was fully charged. Next, the following steps (1) and (2) were repeated, the number of cycles until the terminal voltage of the battery dropped to 1.8 V/cell was examined, and the number of cycles was defined as the life.

(1) The battery is discharged at a 10-hour rate current (4.5 A) of a rated capacity (45 Ah) for 7 hours. That is, the battery is discharged at 70% depth of discharge (DOD) of the rated capacity.

(2) Constant current-constant voltage (CC-CV) charging is performed. Specifically, the battery is charged at a 10-hour rate current (4.5 A) of a rated capacity (45 Ah), and the battery is subjected to constant voltage charging when a terminal voltage of the battery reaches 2.45 V/cell. This charging is performed until the amount of electricity charged reaches 104% of the amount of electricity discharged.

Performance Evaluation and Determination

In the capacity test, when the 10-hour rate capacity (Ah) was equal to or more than the rated capacity, it was determined that the capacity performance was good (∘). When the 10-hour rate capacity was less than the rated capacity, it was determined that the capacity performance was poor (x).

As for the life, when the life was 4,500 cycles or more in the life test described above, it was determined that the battery had life performance to withstand long-term operation (∘). When the life was less than 4,500 cycles, it was determined that the battery cannot withstand long-term operation (x).

Then, when the capacity performance was good and the life performance to withstand long-term operation was exhibited, it was determined as pass (∘) in the comprehensive evaluation.

These results are shown in Tables 1 and 2 together with the configuration of each lead alloy sheet.

TABLE 1

| | | | | | | | Bipolar | | | | | | |
|---|---|---|---|---|---|---|---|---|---|---|---|---|---|
| | | | | | | | lead-acid | | | | | | |
| | | | | | | | storage battery | | Test results and determination | | | | |
| | Positive electrode current collector plate | | | | | | Rated | | 10-Hour | | | | |
| | | | | | Volume: | Corrosive | capacity: | | rate | Capacity | | Life | |
| | | Manufacturing | Thickness | Area | A | amount | B | | capacity | per- | Life | per- | Total |
| N^{o} | Alloy | method | (mm) | (cm²) | (cm³) | (mg/cm²) | (Ah) | A/B | (Ah) | formance | (cycle) | formance | evaluation |
| 1 | A | Rolling | 0.30 | 667.5 | 20 | 140 | 45 | 0.44 | 48 | ◯ | 4000 | X | X |
| 2 | A | Casting | 0.30 | 667.5 | 20 | 110 | 45 | 0.44 | 48 | ◯ | 4100 | X | X |
| 3 | B | Rolling | 0.30 | 667.5 | 20 | 90 | 45 | 0.44 | 48 | ◯ | 4700 | ◯ | ◯ |
| 4 | B | Casting | 0.30 | 667.5 | 20 | 70 | 45 | 0.44 | 48 | ◯ | 4900 | ◯ | ◯ |
| 5 | C | Rolling | 0.30 | 667.5 | 20 | 30 | 45 | 0.44 | 48 | ◯ | 5300 | ◯ | ◯ |
| 6 | C | Casting | 0.30 | 667.5 | 20 | 20 | 45 | 0.44 | 48 | ◯ | 5500 | ◯ | ◯ |
| 7 | D | Rolling | 0.30 | 1001.0 | 30 | 130 | 45 | 0.67 | 45 | ◯ | 4200 | X | X |
| 8 | D | Casting | 0.30 | 1001.0 | 30 | 110 | 45 | 0.67 | 45 | ◯ | 4400 | X | X |
| 9 | E | Rolling | 0.30 | 1001.0 | 30 | 130 | 45 | 0.67 | 45 | ◯ | 4250 | X | X |
| 10 | E | Casting | 0.30 | 1001.0 | 30 | 110 | 45 | 0.67 | 45 | ◯ | 4450 | X | X |

TABLE 2

| | | | | | | | Bipolar | | | | | | |
|---|---|---|---|---|---|---|---|---|---|---|---|---|---|
| | | | | | | | lead-acid | | | | | | |
| | | | | | | | storage battery | | Test results and determination | | | | |
| | Positive electrode current collector plate | | | | | | Rated | | 10-Hour | | | | |
| | | | | | Volume: | Corrosive | capacity: | | rate | Capacity | | Life | |
| | | Manufacturing | Thickness | Area | A | amount | B | | capacity | per- | Life | per- | Total |
| N^{o} | Alloy | method | (mm) | (cm²) | (cm³) | (mg/cm²) | (Ah) | A/B | (Ah) | formance | (cycle) | formance | evaluation |
| 11 | C | Rolling | 0.09 | 445.0 | 4 | 30 | 45 | 0.09 | 54 | ◯ | 3000 | X | X |
| 12 | C | Rolling | 0.09 | 555.0 | 5 | 30 | 45 | 0.11 | 53 | ◯ | 3200 | X | X |
| 13 | C | Rolling | 0.09 | 1109.5 | 10 | 30 | 45 | 0.22 | 52 | ◯ | 3400 | X | X |
| 14 | C | Rolling | 0.09 | 2220.0 | 20 | 30 | 45 | 0.44 | 51 | ◯ | 3600 | X | X |
| 15 | C | Rolling | 0.09 | 3336.0 | 30 | 30 | 45 | 0.67 | 50 | ◯ | 3750 | X | X |
| 16 | C | Rolling | 0.09 | 3558.0 | 32 | 30 | 45 | 0.71 | 49 | ◯ | 3800 | X | X |
| 17 | C | Rolling | 0.10 | 400.0 | 4 | 30 | 45 | 0.09 | 53 | ◯ | 4200 | X | X |
| 18 | C | Rolling | 0.10 | 500.0 | 5 | 30 | 45 | 0.11 | 52 | ◯ | 4500 | ◯ | ◯ |
| 19 | C | Rolling | 0.10 | 1001.0 | 10 | 30 | 45 | 0.22 | 51 | ◯ | 4600 | ◯ | ◯ |
| 20 | C | Rolling | 0.10 | 2000.0 | 20 | 30 | 45 | 0.44 | 49 | ◯ | 4750 | ◯ | ◯ |
| 21 | C | Rolling | 0.10 | 3000.0 | 30 | 30 | 45 | 0.67 | 46 | ◯ | 4900 | ◯ | ◯ |
| 22 | C | Rolling | 0.10 | 3198.0 | 32 | 30 | 45 | 0.71 | 44 | X | 5000 | ◯ | X |
| 23 | C | Rolling | 0.30 | 133.5 | 4 | 30 | 45 | 0.09 | 52 | ◯ | 4300 | X | X |
| 24 | C | Rolling | 0.30 | 166.5 | 5 | 30 | 45 | 0.11 | 51 | ◯ | 4750 | ◯ | ◯ |
| 25 | C | Rolling | 0.30 | 334.0 | 10 | 30 | 45 | 0.22 | 50 | ◯ | 5100 | ◯ | ◯ |
| 5 | C | Rolling | 0.30 | 667.5 | 20 | 30 | 45 | 0.45 | 48 | ◯ | 5300 | ◯ | ◯ |
| 26 | C | Rolling | 0.30 | 1001.0 | 30 | 30 | 45 | 0.67 | 46 | ◯ | 5450 | ◯ | ◯ |
| 27 | C | Rolling | 0.30 | 1067.5 | 32 | 30 | 45 | 0.71 | 43 | X | 5600 | ◯ | X |
| 28 | C | Rolling | 0.50 | 80.0 | 4 | 30 | 45 | 0.09 | 50 | ◯ | 4400 | X | X |
| 29 | C | Rolling | 0.50 | 100.1 | 5 | 30 | 45 | 0.11 | 49 | ◯ | 4850 | ◯ | ◯ |
| 30 | C | Rolling | 0.50 | 199.5 | 10 | 30 | 45 | 0.22 | 48 | ◯ | 5200 | ◯ | ◯ |
| 31 | C | Rolling | 0.50 | 400.0 | 20 | 30 | 45 | 0.44 | 46 | ◯ | 5500 | ◯ | ◯ |
| 32 | C | Rolling | 0.50 | 600.0 | 30 | 30 | 45 | 0.67 | 45 | ◯ | 5650 | ◯ | ◯ |
| 33 | C | Rolling | 0.50 | 639.0 | 32 | 30 | 45 | 0.71 | 42 | X | 5700 | ◯ | X |
| 34 | C | Rolling | 0.60 | 67.0 | 4 | 30 | 45 | 0.09 | 44 | X | 4450 | X | X |
| 35 | C | Rolling | 0.60 | 83.6 | 5 | 30 | 45 | 0.11 | 43 | X | 4900 | ◯ | X |
| 36 | C | Rolling | 0.60 | 166.5 | 10 | 30 | 45 | 0.22 | 42 | X | 5300 | ◯ | X |
| 37 | C | Rolling | 0.60 | 334.0 | 20 | 30 | 45 | 0.45 | 41 | X | 5600 | ◯ | X |
| 38 | C | Rolling | 0.60 | 500.0 | 30 | 30 | 45 | 0.67 | 41 | X | 5750 | ◯ | X |
| 39 | C | Rolling | 0.60 | 532.5 | 32 | 30 | 45 | 0.71 | 40 | X | 5800 | ◯ | X |

From the results in Table 1, it can be found that when the thickness of the positive electrode lead foil 111a is 0.30 mm, the rated capacity is 45 Ah, and A/B is 0.44 or 0.67, if the corrosive amount of the positive electrode lead foil 111a is 90 mg/cm2 or less, both excellent capacity performance and life performance to withstand long-term operation can be achieved.

From the results in Table 2, it can be found that when the corrosive amount of the positive electrode lead foil 111a is 30 mg/cm², the rated capacity is 45 Ah, and A/B is 0.11 or more and 0.67 or less, if the thickness of the positive electrode lead foil 111a is 0.10 mm or more and 0.50 mm or less, both excellent capacity performance and life performance to withstand long-term operation can be achieved.

The following is a list of reference signs used in this specification and in the drawings.
100 Bipolar lead-acid storage battery
110 Cell member
111 Positive electrode
112 Negative electrode
111a Positive electrode lead foil (positive electrode current collector plate arranged on one surface of substrate of biplate)
111aa Positive electrode lead foil (positive electrode current collector plate arranged on one surface of substrate of first end plate)
111b Positive active material layer
112a Negative electrode lead foil (negative electrode current collector plate arranged on the other surface of substrate of biplate)
112aa Negative electrode lead foil (negative electrode current collector plate arranged on one surface of substrate of second end plate)
112b Negative active material layer
113 Separator
120 Biplate
121 Substrate of biplate (substrate that covers both a side of positive electrode and a side of negative electrode of cell member)
121a Through-hole of substrate
121b First recess of substrate
121c Second recess of substrate
122 Frame body of biplate
130 First end plate
131 Substrate of first end plate (substrate that covers one of a side of positive electrode and a side of negative electrode of cell member)
132 Frame body of first end plate
140 Second end plate
141 Substrate of second end plate (substrate that covers one of a side of positive electrode and a side of negative electrode of cell member)
142 Frame body of second end plate
150 Adhesive layer
160 Electrical conductor
C Cell (space housing cell member)

What is claimed is:

1. A bipolar lead-acid storage battery, comprising:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members each forming a plurality of spaces for individually housing the plurality of cell members,
wherein the space forming member includes a substrate that covers at least one of a side of the positive electrode and a side of the negative electrode of the cell member, and a frame body that surrounds a side surface of the cell member,
the cell member and the substrate of the space forming member are arranged to be alternately stacked,
the plurality of cell members are electrically connected in series, and the frame bodies adjacent to each other are joined to each other,
the positive electrode current collector plate includes a lead alloy sheet having a mass loss per total surface area of a test piece of 100 mg/cm² or less when measured after the test piece of the lead alloy sheet is placed in sulfuric acid at a concentration of 38 mass % maintained at a temperature of 60° C., and a continuous anodization is performed at a constant potential of 1,350 mV on a mercury/mercury sulfate reference electrode for 28 days,
a thickness of the positive electrode current collector plate arranged on one surface of the substrate that covers both a side of the positive electrode and a side of the negative electrode of the cell member is 0.10 mm or more and 0.50 mm or less, and
a ratio (A/B) of a volume A (cm³) of the positive electrode current collector plate arranged on the one surface of the substrate to a rated capacity B (Ah) of the bipolar lead-acid storage battery is 0.11 or more and 0.67 or less.

2. The bipolar lead-acid storage battery according to claim 1, wherein the bipolar lead-acid storage battery is used in a state where a charge amount does not exceed 100% of a rated capacity.

3. A method for manufacturing a bipolar lead-acid storage battery,
wherein the bipolar lead-acid storage battery includes:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members each forming a plurality of spaces for individually housing the plurality of cell members,
the space forming member includes a substrate that covers at least one of a side of the positive electrode and a side of the negative electrode of the cell member, and a frame body that surrounds a side surface of the cell member,
the cell member and the substrate of the space forming member are arranged to be alternately stacked,
the plurality of cell members are electrically connected in series, and the frame bodies adjacent to each other are joined to each other,
as the positive electrode current collector plate arranged on one surface of the substrate that covers both the side of the positive electrode and the side of the negative electrode of the cell member,
a lead alloy sheet having a thickness of 0.10 mm or more and 0.50 mm less is used, in which a mass loss per total surface area of a test piece is 100 mg/cm² or less when measured after the test piece of the lead alloy sheet is placed in sulfuric acid at a concentration of 38 mass % maintained at a temperature of 60° C., and a continuous anodization is performed at a constant potential of 1,350 mV on a mercury/mercury sulfate reference electrode for 28 days, and
a volume A (cm³) of the positive electrode current collector plate arranged on the one surface is set so that a ratio (A/B) of the volume A of the positive electrode current collector plate to a rated capacity B (Ah) of the bipolar lead-acid storage battery is 0.11 or more and 0.67 or less.
